(19) United States
(12) Patent Application Publication
(10) Pub. No.: US 2006/0244381 A1
(43) Pub. Date: Nov. 2, 2006

(54) Pdp having additional thin layers in the electrode pad

(76) Inventors: Seak Ki Kim, Busan (KR); Hae Seong Chang, Choongcheongnam-do (KR); Kwang Pyo Choi, Gyoungsangbuk-do (KR)

Correspondence Address: DICKSTEIN SHAPIRO LLP, 1825 EYE STREET NW, Washington, DC, 20006-5403, US

(21) Appl. No.: 10/556,884

(22) PCT Filed: May 19, 2004
(86) PCT No.: PCT/KR04/01190

§ 371 Date: Nov. 15, 2005

(30) Foreign Application Priority Data
May 20, 2003 (KR) 10-2003-0031818

(51) Int. Cl. H01J 17/49

(52) U.S. Cl. 313/586; 313/582; 313/583; 313/587

(57) ABSTRACT

A plasma display panel is disclosed. The plasma display panel having an additional thin layer between each electrode and a glass substrate in an electrode pad region minimizes migration of the electrode which results from a potential difference between the electrodes while the PDP is driven.

### TECHNICAL FIELD

The present invention generally relates to a plasma display panel, and more specifically, to an AC plasma display panel where an electrode of an electrode pad is not directly formed on a glass substrate but an additional thin layer is formed between the glass substrate and the electrode of the electrode pad, thereby minimizing migration of electrodes.

### BACKGROUND ART

A plasma display panel (hereinafter, referred to as “PDP”) has a panel formed by sealing two substrates spaced from each other at a predetermined distance. The space between two substrates is filled with discharge gas. A group of electrodes, which are formed on each substrate has its end portion extended to an external end portion of the substrate for connection with external driving circuits. This connection region of the electrode group is entitled as an electrode pad.

Generally, an electrode of the electrode pad which is formed of metal having low resistance such as silver (Ag) is directly formed on a glass substrate in a prior art. In driving this PDP, a potential difference is generated between the electrodes, this potential difference leading ions of each electrode to being combined with a metal electrode of the glass substrate. Therefore, the adjacent electrodes are shorted, which is called migration.

FIG. 1 is a diagram illustrating migration generated from electrode pads of a conventional plasma display panel.

When an electric field is applied to metal, the metal in an anode is dissolved and moves through non-metal material to a cathode due to effect of the electric field. This phenomenon may cause short between the metal electrodes.

FIG. 2 is a diagram illustrating the actual shape of the migration generated between electrodes.

When electrodes X and Y are fetched to the same electrode pad in order to embody a large multi-screen having four plasma display panels connected seamlessly, the interval between the electrodes becomes narrower so that the short between the electrodes which results from the migration becomes a serious problem.

### BRIEF DESCRIPTION OF THE DRAWINGS

FIG. 1 is a diagram illustrating migration generated from an electrode pad of a conventional plasma display panel.

FIG. 2 is a diagram illustrating the actual shape of the migration generated between electrodes.

FIG. 3 is a diagram illustrating an electrode pad of a plasma display panel according to a first embodiment of the present invention.

FIG. 4 is a diagram illustrating an electrode pad of a plasma display panel according to a second embodiment of the present invention.

FIG. 5 is a diagram illustrating an electrode pad of a plasma display panel according to a third embodiment of the present invention.

FIG. 6 is a diagram illustrating an electrode pad of a plasma display panel according to a fourth embodiment of the present invention.

FIG. 7 is a diagram illustrating an electrode pad of a plasma display panel according to a fifth embodiment of the present invention.

FIG. 8 is a diagram illustrating an electrode pad of a plasma display panel according to a sixth embodiment of the present invention.

FIG. 9 is a cross-sectional diagram illustrating the cross section cut in a direction A-A′ of FIG. 6.

FIG. 10 is a diagram illustrating an electrode pad of a plasma display panel according to a seventh embodiment of the present invention.

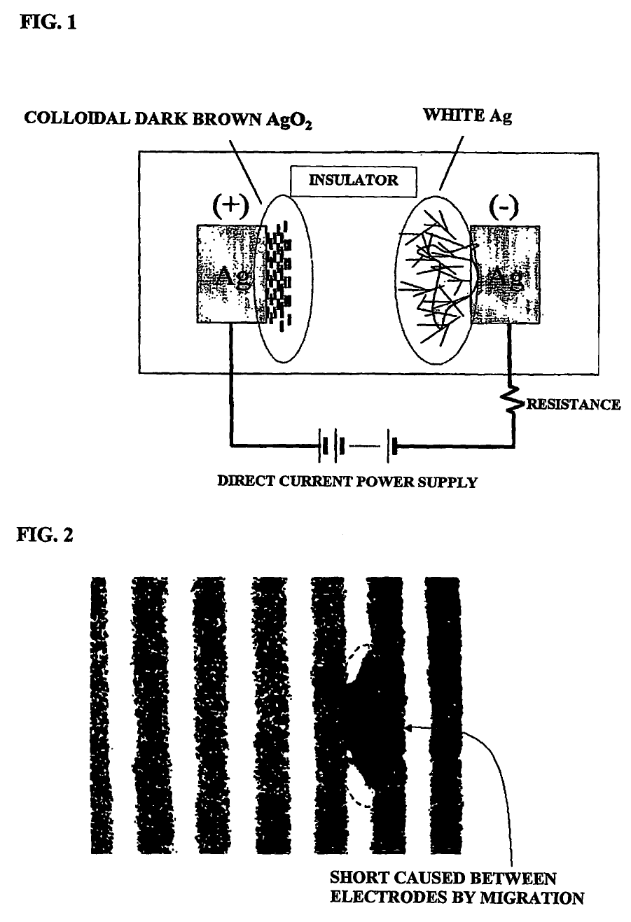

### DETAILED DESCRIPTION OF THE INVENTION

Technical Subject

Accordingly, it is an object of the present invention to minimize migration by forming an additional thin layer between a glass substrate and each electrode of an electrode pad.

Technical Solution

There is provided a plasma display panel including a front substrate and a rear substrate, which each has side portion extended in a different direction. This side portion becomes an electrode pad region where electrodes of the substrate are fetched to be coupled with an external driving circuit. The plasma display panel comprises at least one or more additional thin layers formed between the electrode and the substrate for preventing the electrode of the electrode pad region from being directly contacted with the substrate.

### PREFERRED EMBODIMENTS

The present invention will be described in detail with reference to the accompanying drawings.

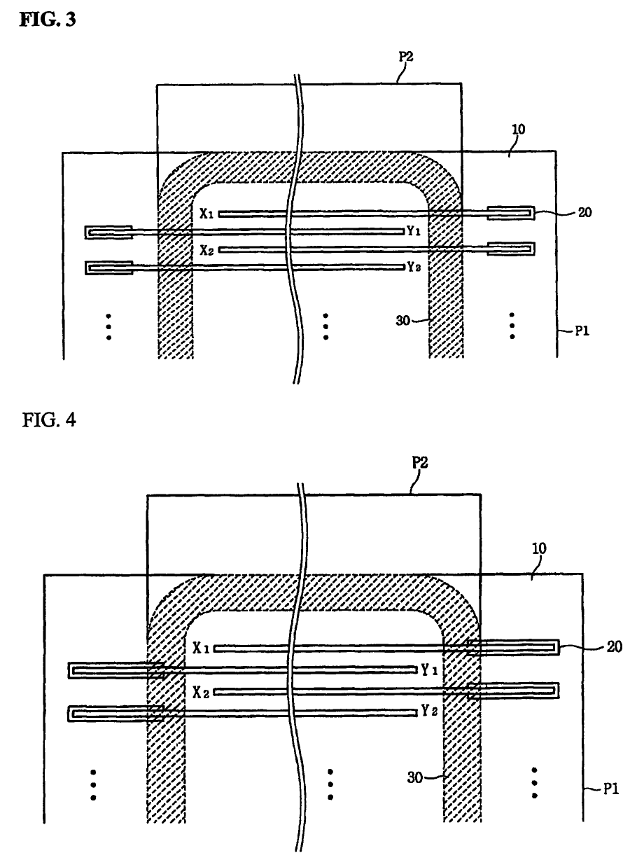

FIGS. 3 to 5 are diagrams illustrating an electrode pad of a plasma display panel according to first to third preferred embodiment of the present invention.

In an embodiment, a thin layer 20 (hereinafter, referred to as “additional thin layer”) is additionally formed between a glass substrate 10 and electrodes X (X₁, X₂, . . . ) and Y (Y₁, Y₂, . . . ) fetched in the electrode pad region, so that metal ions (i.e. Ag) of each electrode X and Y may not be flow into the glass substrate 10.

First to third embodiments disclosed in FIGS. 3 to 5 presumes that the electrode X (X₁, X₂, . . . ) is fetched in an opposite direction to that of the electrode Y (Y₁, Y₂, . . . ). And, each of FIGS. 3 to 5 illustrates example in which the length of the additional thin layer is different from each other.

The width of the additional thin layer 20 is larger than or the same as that of the electrode X or Y of the electrode pad, and is formed with the same shape that of the electrode X or Y fetched to the electrode pad so that the electrodes X and Y may not be directly contacted with the glass substrate 10. The additional thin layer in the embodiments is formed with a belt type having a predetermined length toward the internal direction of the panel. Each of the additional thin layers 20 is separated from other adjacent additional thin layers 20 not to be connected with each other.

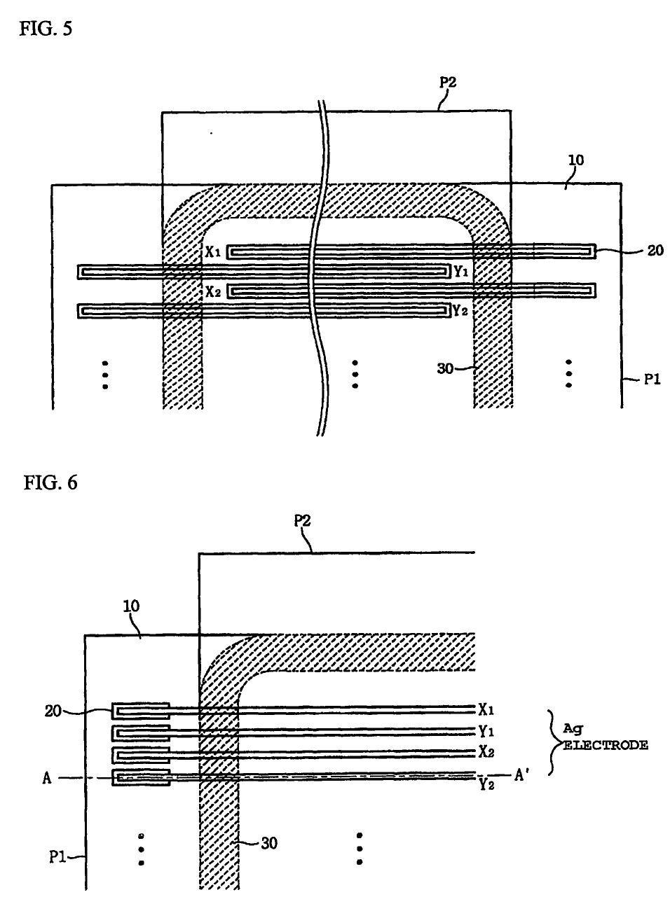

The additional thin layer 20 may be formed of the same material as a transparent substrate ITO (not shown) formed in a display region (not shown) of the plasma display panel. The material used in the transparent substrate ITO is used as the additional thin layer 20 so that an additional process or material for formation of the additional thin layer 20 is not required. That is, when the transparent substrate ITO (not shown) is formed in the display region (not shown), the additional thin layer 20 is patterned with the transparent substrate ITO. Unlike the embodiments disclosed in FIGS. 3 and 4, the ITO film in the display region is connected with the additional thin layer 20 in the embodiment of FIG. 5.

Since the ITO is formed with a pure crystalline type on the substrate, and has low moisture and reactivity, the migration phenomenon can be remarkably prevented.

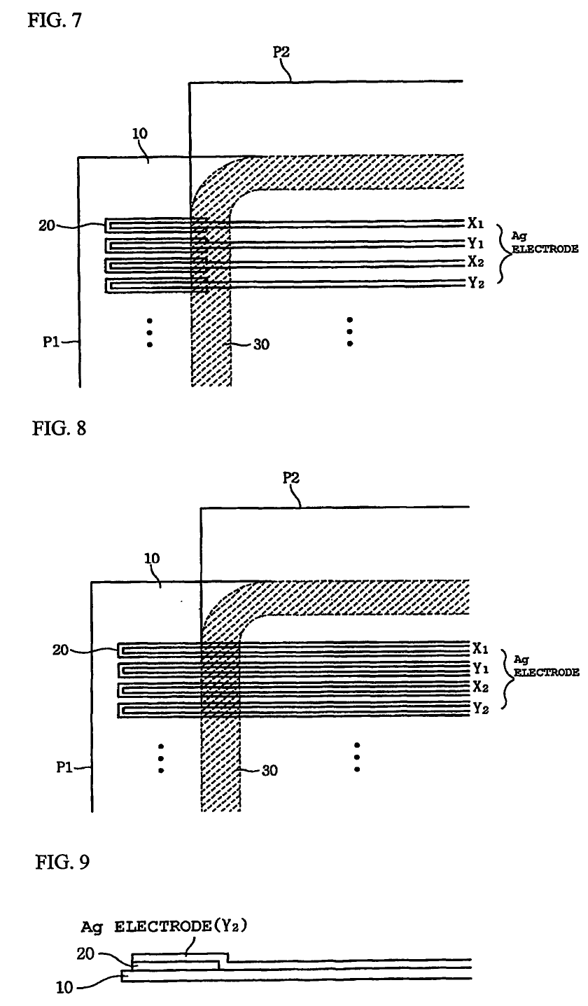

FIGS. 6 to 8 are diagrams illustrating an electrode pad of a plasma display panel according to fourth to sixth preferred embodiments of the present invention.

In the preferred embodiments of FIGS. 6 to 8, electrodes X and Y are fetched to one direction for displaying a plurality of plasma display panels seamlessly with a large screen.

Here, a multi-plasma display panel is exemplified where the electrodes X and Y are fetched only to one direction so that they may be displayed to the edge of the opposite side to minimize the width between the display regions.

Since the electrodes X and Y are fetched only to one direction in this preferred embodiment, the width between the electrodes becomes narrower than in the first to second preferred embodiments. As a result, the structure of the electrode becomes weak to the migration. Therefore, the additional thin layer 20 is more required in the electrode structure of the preferred embodiment.

The explanation on formation of the additional thin layer 20 of the preferred embodiment is omitted because it is the same as that of the first to third preferred embodiments.

FIG. 9 is a cross-sectional diagram illustrating the cross section cut in a direction A-A′ of FIG. 6. The additional thin layer 20 having a predetermined length is formed on the glass substrate 10 of the electrode pad, and then the electrode Y₂ is formed thereon. Here, since the additional thin layer ITO 20 may be formed of a thin film, limit by the height of the additional thin layer 20 is not generated when other structures are formed.

Additionally, suppose that the additional thin layer 20 is formed of the same material as that of the transparent substrate ITO (not shown) of the display region (not shown). When the transparent substrate ITO (not shown) is formed in the display region, the additional thin layer 20 is formed together so that an additional process is not required.

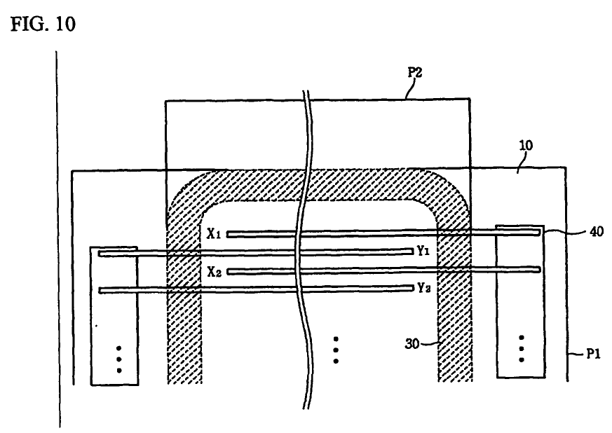

In the above-described embodiments, the additional thin layers 20 are formed to correspond one by one to the electrodes X and Y, respectively, so that each of the additional thin layers 20 may be separated from each other because the additional thin layer 20 is formed of the same material as that of the transparent substrate ITO. Therefore, when the additional thin layer is formed with insulating material with which a thin film is fabricated, the additional thin layers are not separated to correspond one-by-one to the electrodes X and Y. Instead, an additional thin layer 40 may be formed to correspond to the whole electrodes X and Y as shown in FIG. 10.

In case of FIGS. 6 to 8, when the additional thin layer is formed of insulating material, an additional thin layer corresponding to all electrodes X and Y can be formed.

### INDUSTRIAL APPLICABILITY

As discussed earlier, in a plasma display panel according to an embodiment of the present invention, an electrode of an electrode pad is formed on an additional thin layer of a thin film, thereby minimizing migration of electrodes.

1. A plasma display panel including a front substrate and a rear substrate, each having side portion extended in a different direction from the other substrate, the side portion becoming an electrode pad region where electrodes are fetched to be coupled with an external driving circuit, comprising at least one or more additional thin layers formed between the electrode and the substrate, for preventing the electrode in the electrode pad region from being directly contacted with the substrate.

2. The plasma display panel according to claim 1, wherein the width of at least one or more additional thin layers is larger than or the same as that of the electrode.

3. The plasma display panel according to claim 2, wherein at least one or more additional thin layers are an ITO film.

4. The plasma display panel according to claim 3, wherein at least one or more additional thin layers which correspond one by one to the electrodes are a plurality of thin films which are not interconnected.

5. The plasma display panel according to claim 3, wherein at least one or more additional thin layers are extended with a belt type toward an inside of the panel.

6. The plasma display panel according to claim 3, wherein at least one or more additional thin layers have a length which is not connected to a transparent substrate of the panel.

7. The plasma display panel according to claim 2, wherein at least one or more additional thin layers are formed of insulating materials.

8. The plasma display panel according to claim 7, wherein at least one or more additional thin layers are interconnected.

9. The plasma display panel according to claim 3, wherein at least one or more additional thin layers are not overlapped with sealing materials for sealing the front substrate with the rear substrate or overlapped with a portion of the sealing materials.

10. The plasma display panel according to claim 4, wherein at least one or more additional thin layers are extended with a belt type toward an inside of the panel.

11. The plasma display panel according to claim 4, wherein at least one or more additional thin layers have a length which is not connected to a transparent substrate of the panel.

12. The plasma display panel according to claim 7, wherein at least one or more additional thin layers are not overlapped with sealing materials for sealing the front substrate with the rear substrate or overlapped with a portion of the sealing materials.
